(19) United States
(12) Patent Application Publication
(10) Pub. No.: US 2016/0259571 A1
(43) Pub. Date: Sep. 8, 2016

(54) STORAGE SUBSYSTEM

(71) Applicant: HITACHI, LTD., Tokyo (JP)

(72) Inventors: Hiroyuki KUMASAWA, Tokyo (JP); Yuji YAMAGUCHI, Tokyo (JP)

(73) Assignee: HITACHI, LTD., Tokyo (JP)

(21) Appl. No.: 14/424,156

(22) PCT Filed: Jun. 6, 2014
(86) PCT No.: PCT/JP2014/065072

§ 371 Date: Feb. 26, 2015

(51) Int. Cl. G06F 3/06; G06F 12/08

(52) U.S. Cl. CPC G06F 3/0619; G06F 3/0647; G06F 3/0685; G06F 12/0802; G06F 2212/222

(57) ABSTRACT

The storage subsystem according to the present invention is equipped with a cache memory having a nonvolatile memory and a volatile memory. Write data sent from a superior device is stored in the nonvolatile memory, and data subjected to a read request from the superior device is cached from a final storage media to the volatile memory. When power supply from an external power supply has stopped, data having a high access frequency out of the data stored in the volatile memory is backed up in a nonvolatile memory, and when power supply from the external power supply is resumed, the data backed up from the volatile memory to the nonvolatile memory is migrated again to the volatile memory.

### TECHNICAL FIELD

The present invention relates to a storage subsystem which uses a nonvolatile semiconductor memory as a cache.

### BACKGROUND ART

Storage subsystems using a nonvolatile semiconductor storage media, a typical example of which is a flash memory, has been proposed. However, since there are limitations related to the unit for writing data and the like in a nonvolatile semiconductor storage media, they are often used in combination with volatile storage media.

For example, Patent Literature 1 discloses an invention of a storage subsystem where data specified by a write request from a superior device is temporarily stored in a volatile memory, and when power supply is stopped, data is transferred from the volatile memory to a nonvolatile memory using power supplied from an auxiliary power supply to ensure data integrity.

### CITATION LIST

### Patent Literature

Japanese Patent Application Laid-Open Publication No. 2013-25400

### SUMMARY OF INVENTION

### Technical Problem

According to the art taught in Patent Literature 1, when the capacity of an auxiliary power supply is insufficient, the data may not be migrated from the volatile memory to the nonvolatile memory, and data may be lost.

Further, since the art taught in Patent Literature 1 is an invention characterized in using the nonvolatile memory as a final storage media, when the system has recovered from the state where power has stopped, it is assumed that all the data are to be read from the final storage media. Therefore, the data having been stored in the volatile memory, which is one type of a cache, cannot be used after the power supply has recovered (and the data must be read from the final storage media), so that the access performance is deteriorated.

### Solution to Problem

The storage subsystem according to the present invention is equipped with a cache memory having a nonvolatile memory and a volatile memory. The write data sent from a superior device is stored in the nonvolatile memory, and the data subjected to a read request from the superior device is cached from the final storage media to the volatile memory.

When the power supply from the external power supply has stopped, the present invention performs backup of the data having a high access frequency out of the data stored in the volatile memory to the nonvolatile memory, and when power supply from the external power supply has resumed, the data hacked up in the nonvolatile memory from the volatile memory is migrated back to the volatile memory.

### Advantageous Effects of Invention

According to the storage subsystem of the present invention, data loss can be prevented even after a failure such as a power shutdown has occurred. Moreover, a large amount of data having a high access frequency remains in the cache even when failure such as power shutdown occurs, so that the present invention enables to maintain the effect of improved access performance by the cache.

### BRIEF DESCRIPTION OF DRAWINGS

FIG. 1 is a configuration diagram of a storage subsystem according to a preferred embodiment of the present invention.

FIG. 2 shows a concept of a caching method in the storage subsystem according to the preferred embodiment of the present invention.

FIG. 3 shows a content of a cache management table managed by the storage subsystem according to the preferred embodiment of the present invention.

FIG. 4 illustrates one example of a screen for setting up configuration information in the storage subsystem according to the preferred embodiment of the present invention.

FIG. 5 illustrates one example of a screen for setting up the configuration information in the storage subsystem according to the preferred embodiment of the present invention.

FIG. 6 is a flowchart illustrating a read processing according to the preferred embodiment of the present invention.

FIG. 7 is a flowchart of a write processing according to the preferred embodiment of the present invention.

FIG. 8 is a flowchart of a destage processing according to the preferred embodiment of the present invention.

FIG. 9 is a flowchart of a destage necessity determination processing according to the preferred embodiment of the present invention.

FIG. 10 is a flowchart of a clean data migration processing according to the preferred embodiment of the present invention.

FIG. 11 is a flowchart of a backup processing according to the storage subsystem of the preferred embodiment of the present invention.

FIG. 12 is a flowchart of a recovery processing in the storage subsystem according to the preferred embodiment of the present invention.

### DESCRIPTION OF EMBODIMENTS

Now, a storage system (storage subsystem) according to a preferred embodiment of the present invention will be described with reference to the drawings. The present invention is not restricted to the embodiment illustrated below.

### Embodiment

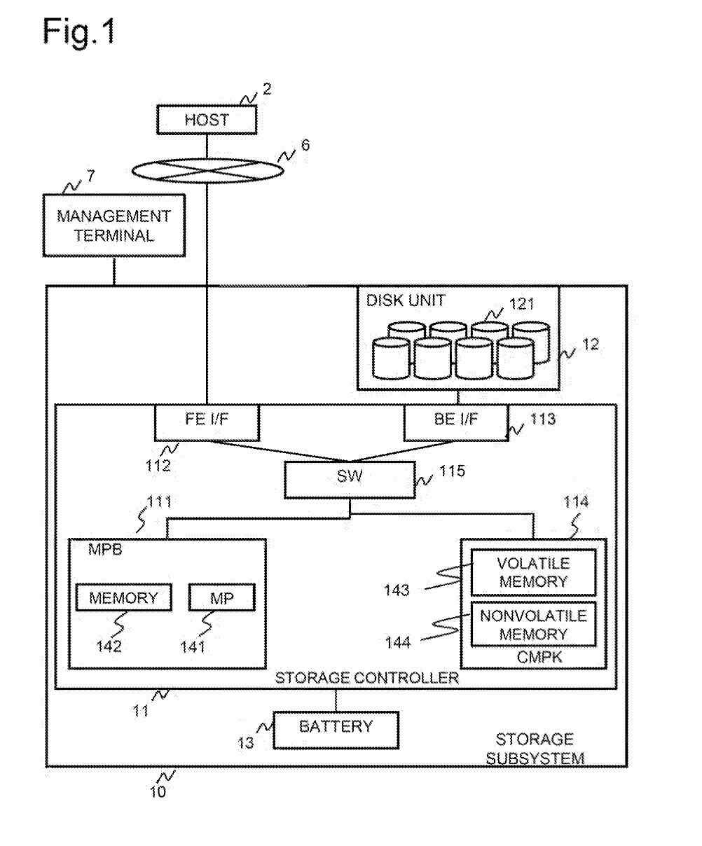

FIG. 1 illustrates a configuration of a storage subsystem 10 according to one preferred embodiment of the present invention. The storage subsystem 10 is composed of a storage controller (hereinafter sometimes abbreviated as “controller”) 11, a disk unit 12 including multiple drives 121, and a battery 13. The storage controller 11 adopts a configuration where an MPB 111 which is a processor board for executing processing and other control performed in the storage, subsystem 10, a frontend interface (FE I/F) 112 which is a data transfer interface with the host 2, a backend interface (BE I/F) 113 which is a data transfer interface with the disk unit, and a cache memory package (CMPK) 114 having a memory for storing cache data and control information, are mutually connected via a switch (SW) 115. The number of the respective components (the MPB 111, the FE I/F 112, the BE I/F 113 and the CMPK 114) is not restricted to the number illustrated in FIG. 1. Normally, multiple numbers of components are installed to ensure high availability.

The battery 13 is for supplying power to the controller 11 when a failure such as power outage occurs. Although not shown, in addition to the battery 13, an external power supply is connected to the storage subsystem 10, and during the normal state (when power is supplied from the external power supply), the storage subsystem 10 uses the power supplied from the external power supply for operation. The controller 11 has a function to switch the power supply source, so that when power supply from the exterior is stopped due for example to a power failure, the controller 11 switches the power supply source from the external power supply to the battery 13, to perform a backup processing of data in the CMPK 114 described later using the power supplied from the battery 13.

Each MPB 111 has a processor (referred to as MP in the drawing) 141, and a local memory 142 storing control programs executed by the processor 141 and control information used by the control programs. The read/write processing, destage processing, backup processing and the like described later will be realized by the processor 141 executing the programs stored in the local memory 142.

The CMPK 114 has a volatile memory 143 formed of a volatile semiconductor storage medium such as a DRAM, and a nonvolatile memory 144 formed of a nonvolatile semiconductor storage medium, such as a flash memory, capable of being rewritten and retaining data without the power supply from an external power supply or a battery. Though it will be described in detail later, the volatile memory 143 and the nonvolatile memory 144 each has an area (cache area) used as a so-called disk cache for temporarily storing the write data from the host 2 or data read from the drive 121, and an area for storing the management information of the relevant cache area.

Multiple drives 121 are provided in the disk unit 12. The respective drives 121 are each a storage medium for mainly storing write data from the host 2. HDDs and other magnetic disks are used as an example of the drives 121, but storage media other than magnetic disks, such as SSDs (Solid State Drives) can also be used.

The FE I/F 112 is an interface for performing data transmission and reception via the SAN 6 with the host 2, which has a DMA (Direct Memory Access) controller (not shown) as an example, and has a function to perform processes to transmit write data from the host 2 to the CMPK 114 or to transmit the data in the CMPK 114 to the host 2 based on the instructions from the processor 141. The BE I/F 114 is an interface for performing data transmission and reception with the drive 121, which has a DMA controller similar to the FE I/F 112, and has a function to transmit the data in the CMPK 114 to the drive 121 or to transmit the data in the drive 121 to the CMPK 114 based on the instructions from the processor 141.

The SAN 6 is a network used for transmitting access requests (I/O requests) and read data or write data accompanying the access requests when the host 2 accesses (read/write) the data in the storage area (volume) within the storage subsystem 10, and in the present embodiment, the network is formed using a Fibre Channel. However, it is also possible to adopt a configuration using an Ethernet or other transmission media.

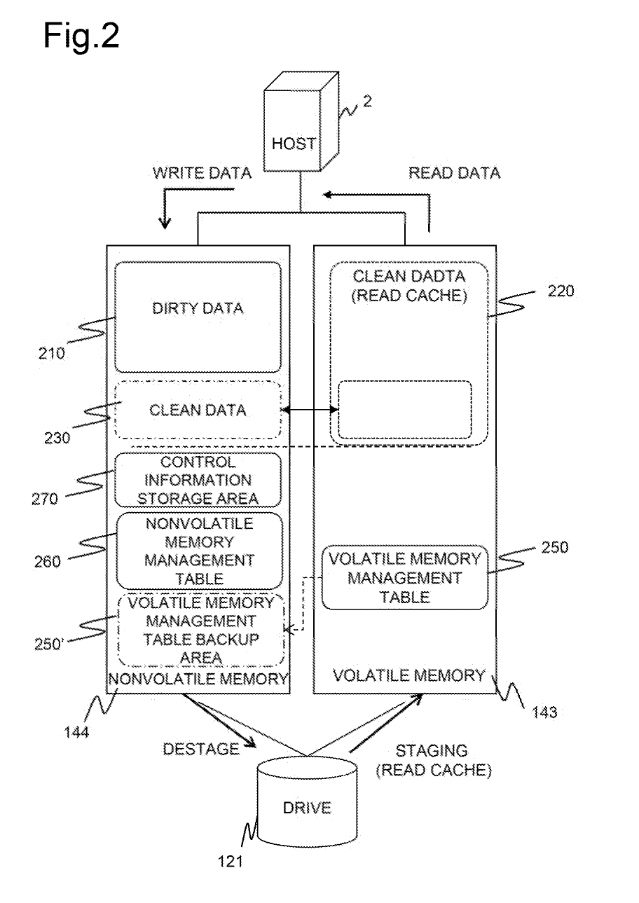

Next, the outline of a data caching method in the storage subsystem 10 according to the preferred embodiment of the present invention will be described with reference to FIG. 2.

In the storage subsystem 10 according to the embodiment of the present invention, the write data from the host 2 is stored in the drive 121 in the end. However, in order to improve the access performance, the storage subsystem 10 temporarily stores (caches) the write data from the host 2 or the data read from the drive 121 in the volatile memory 143 and/or the nonvolatile memory 144 within the CMPK 114. Hereafter, the volatile memory 143 and the nonvolatile memory 144 are collectively referred to as a “disk cache”. Further, in the storage subsystem 10 according to the embodiment of the present invention, write hack method is adopted as a way for writing data to the disk cache. Therefore, when a write request is received from the host 2, a response notifying that the write processing has been completed is sent to the host 2 at the point of time when write data specified by the relevant write request is written into the disk cache.

According to the write back method, even when the write data from the host 2 stored in the disk cache is not reflected in the drive 121, a response notifying that the write processing has been completed is sent to the host 2. The data in this state, that is, the data that is not yet reflected in the drive 121 out of the write data sent from the host 2 and stored in the disk cache is called “dirty data”. If a method to store the write data from the host 2 to the volatile memory 143 is adopted, if power supply to the storage subsystem 10 has stopped due to power failure or the like, the dirty data stored in the volatile memory 143 may be lost. Therefore, in the storage subsystem 10 according to the present embodiment, when storing the write data sent from the host 2 in the disk cache, the data is stored in the nonvolatile memory 144. Then, a process to write the write data stored in the nonvolatile memory 144 to the drive is performed asynchronously as the write request from the host 2. This process is called a destage processing in the present specification. Hereafter, out of the data stored in the disk cache, the data that is already reflected in the drive (that is, the data whose content cached in the disk cache and the content of data in the drive 121 coincide) is called “clean data”.

According to the storage subsystem 10 of the present embodiment, when a request to read the data stored in the drive 121 is received from the host 2, the storage subsystem 10 reads data from the drive 121 (when the read target data is not stored in the disk cache), returns the same to the host 2, and stores the relevant data in the volatile memory 143. Thereby, when the storage subsystem 10 receives a read request of the relevant data again, it should simply read the data from the volatile memory 143, so that the access performance can be improved.

That is, according to the storage subsystem 10 of the present embodiment, the write data (data designated by the write request from the host 2) is stored in the nonvolatile memory 144, and the read data (data designated by the read request from the host 2) is stored in the volatile memory 143. Therefore, only clean data exists in the volatile memory 143, and dirty data and clean data exists in a mixture in the nonvolatile memory 144. Further, the clean data in the nonvolatile memory 144 (element 230 in the drawing) may be migrated to the volatile memory 143, or conversely, the clean data in the volatile memory 143 may be migrated to the nonvolatile memory 144. These processes will be described in detail later.

The storage subsystem 10 stores and manages the information for managing the data cached in the volatile memory 143 to a volatile memory management table 250 disposed in the volatile memory 143. Further, the storage subsystem 10 stores and manages the information for managing data cached in the nonvolatile memory 144 to a nonvolatile memory management table 260 disposed in the nonvolatile memory 144. Further, a control information storage area 270 is disposed in the nonvolatile memory 144. Out of the management information and the control information used in the storage subsystem 10, the control information storage area 270 is used to store information other than the volatile memory management table 250 and the nonvolatile memory management table 260. Further, a volatile memory management table backup area 250′ is formed in the nonvolatile memory 144, and this area is used when power supply from the exterior is stopped due to failure of the external power supply.

According to the storage subsystem 10 of the preferred embodiment of the present invention, one or more logical volumes are created using the storage area of one or multiple drives 121 within the disk unit 12. Then, the host 2 is caused to access the created logical volume. The logical volume is sometimes referred to as a “logical unit” or an “LU”. The storage subsystem 10 assigns a unique identification number to each logical volume for management, and the identification number is called a logical unit number (LUN). When the host 2 accesses (such as reads or writes) the logical volume provided by the storage subsystem 10, access is performed by designating the LUN and the position information (logical block address; also abbreviated as LBA) of the access target area within the logical volume.

Next, we will describe the outline of the method for managing the area in the disk cache of the storage subsystem 10 according to the preferred embodiment of the present invention. The storage subsystem 10 divides the area in the disk cache (volatile memory 143, nonvolatile memory 144) to fixed size areas called slots, and a unique identification number is assigned to each slot for management. This identification number is called a slot number (Slot #), In the preferred embodiment of the present invention, the size of the slot is a sector (512 bytes) which is a minimum access unit for the host 2 to access the logical volume, but other sizes, such as 16 KB, 64 KB and the like can also be adopted. As for the slot number assigned to each slot of the volatile memory 143 and the nonvolatile memory 144, a number that is unique within the volatile memory 143 or the nonvolatile memory 144 is used. Therefore, a slot having a slot number 1 exists both in the volatile memory 143 and also in the nonvolatile memory 144.

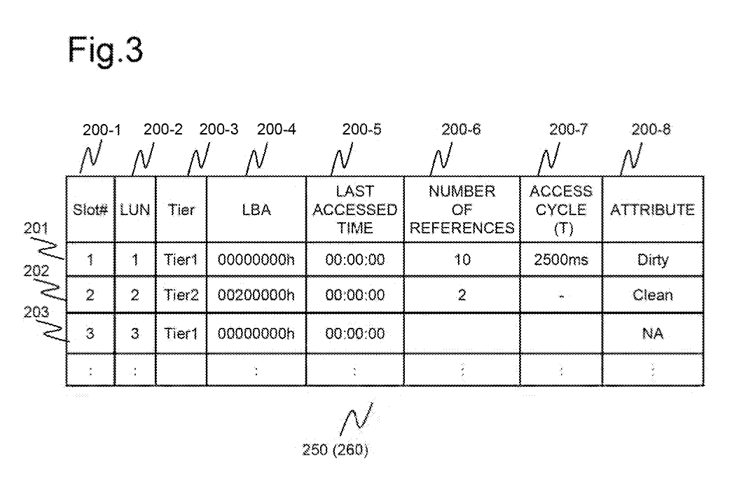

Hereafter, the information stored in the volatile memory management table 250 and the nonvolatile memory management table 260 will be described with reference to FIG 3. The information of each slot is stored in the volatile memory management table 250 and the nonvolatile memory management table 260. FIG. 3 illustrates a format of the volatile memory management table 250 and the nonvolatile memory management table 260. Both the volatile memory management table 250 and the nonvolatile memory management table 260 are tables adopting the format illustrated in FIG. 3. In the volatile memory management table 250 and the nonvolatile memory management table 260, information on LUN (200-2), tier (200-3), LBA (200-4), last accessed time (200-5), reference count (200-6), access cycle (200-7) and attribute (200-8) are stored for each slot (slot specified by slot #(200-1)).

As shown in FIG. 2, the volatile memory management table 250 is stored in the volatile memory 143, and the nonvolatile memory management table 260 is stored in the nonvolatile memory 144. The volatile memory management table 250 is used to store information related to the respective slots in the volatile memory 143, and the nonvolatile memory management table 260 is used to store information related to the respective slots in the nonvolatile memory 144.

The LUN (200-2) and the LBA (200-4) store information showing that the data stored (cached) in the slot specified by the slot #(200-1) is data in the area of the logical volume specified b the LUN (200-2) and the LBA (200-4). The last accessed time (200-5), the reference count (200-6) and the access cycle (200-7) each store the information on the time in which the relevant data (data stored in the slot specified by the slot #(200-1)) has last been accessed, the number of accesses thereto, and the cycle of accesses. The definition of the access cycle according to the present specification will be described later.

The attribute (200-8) stores information showing the status of the data stored in the slut specified by the slot #(200-11 Specifically, information selected from the following is stored: Dirty. Clean, and NA. If Dirty is stored in the attribute (200-8) of a certain slot, it means that dirty data, that is, data not yet reflected in the drive 121, is stored in the relevant Slot, and if Clean is stored, it means that clean data is stored in the relevant, slot, that is, the contents of the data stored in the drive 121 and the data stored in the slot are the same. If NA is stored it means that the data in the slot is invalid, or that the relevant slot is not used. As described earlier, only clean data is stored in the volatile memory 143, so that. Dirty will not be stored in the attribute (200-8) of the volatile memory management table 250.

Tier (200-3) shows the information related to the storage tier of the logical volume specified by the LUN (200-2), In the storage subsystem 10 of the present embodiment, the concept of storage tier is defined. Specifically, the storage subsystem 10 defines three tiers, Tier1, Tier2 and Tier3, and each logical volume belongs to any one tier out of Tier1, Tier2 and Tier3. The tier to which each logical volume belongs is determined by the administrator of the storage subsystem 10 or the host 2, and the tier to which each logical volume belongs is set by the administrator using a management terminal. The set information is stored in a management table (not shown) of the logical volume managed by the storage subsystem 10.

The logical volume belonging to Tier1 is used to store important data and data having a high access frequency, and the logical volume belonging to Tier2 is used to store data which has middle importance, or data having an access frequency not higher than the data stored in the logical volume belonging to Tier1. The logical volume belonging to the tier of Tier3 is used to store data having a low importance, or a data having a lower access frequency than the data stored in the logical volume belonging to Tier2.

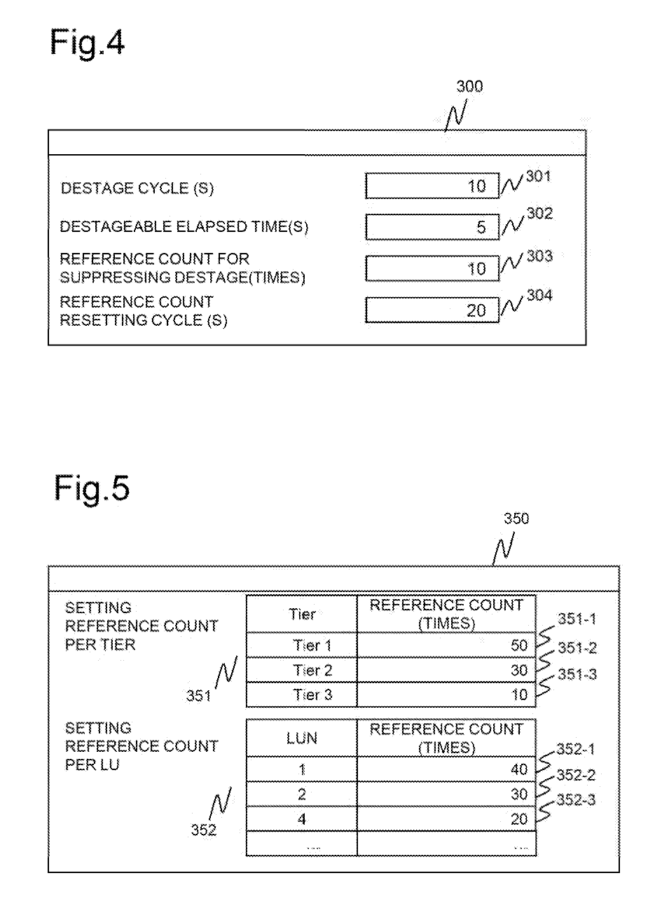

Next, the other control information used in the disk cache control method of the storage subsystem 10 according to the preferred embodiment of the present invention will be described with reference to FIGS. 4 and 5. FIGS. 4 and 5 are views showing one example of a screen for setting the control information of a management terminal 7 of the storage subsystem 10.

The setting screen of FIG. 4 is an example of the screen for setting the information of a destage cycle (301), a destageable elapsed time (302), a reference count for suppressing destage (303), and a reference count resetting cycle (304). The storage subsystem 10 according to the present embodiment executes the destage processing periodically, and the destage processing is performed per time (unit of which is seconds) set in the destage cycle (301). In the example of FIG. 4, “10” is set in the field of the destage cycle (301), so that in this case, destage processing is performed once every 10 seconds.

The destageable elapsed time (302) and the reference count for suppressing destage (303) are information used for determining whether destaging of dirty data stored in each slot of the nonvolatile memory 144 is required or not during the destage processing. The actual use of these information will be described later. The reference count resetting cycle (304) is also information used during the destage processing, so the actual method of use will be described later.

The setting screen of FIG. 5 is for setting the information used for determining whether destaging is necessary or not, and sets two types of information, which are a reference count per tier 351 and a reference count per LU 352. Although the details will be described later, in the process for determining whether destaging is required or not, according to the embodiment of the present invention, destaging will not be performed to the data stored in the disk cache (nonvolatile memory 144) whose reference count is equal to a given number or greater. Specifically, destaging will not be performed if the reference count of the slot in the nonvolatile memory 144 is equal to or greater than the reference count per tier 351 or the reference count per LU 352.

When the administrator uses this setting screen displayed on the management terminal 7 to enter the various information described above, these information will be stored in the control information storage area 270 within the nonvolatile memory 144.

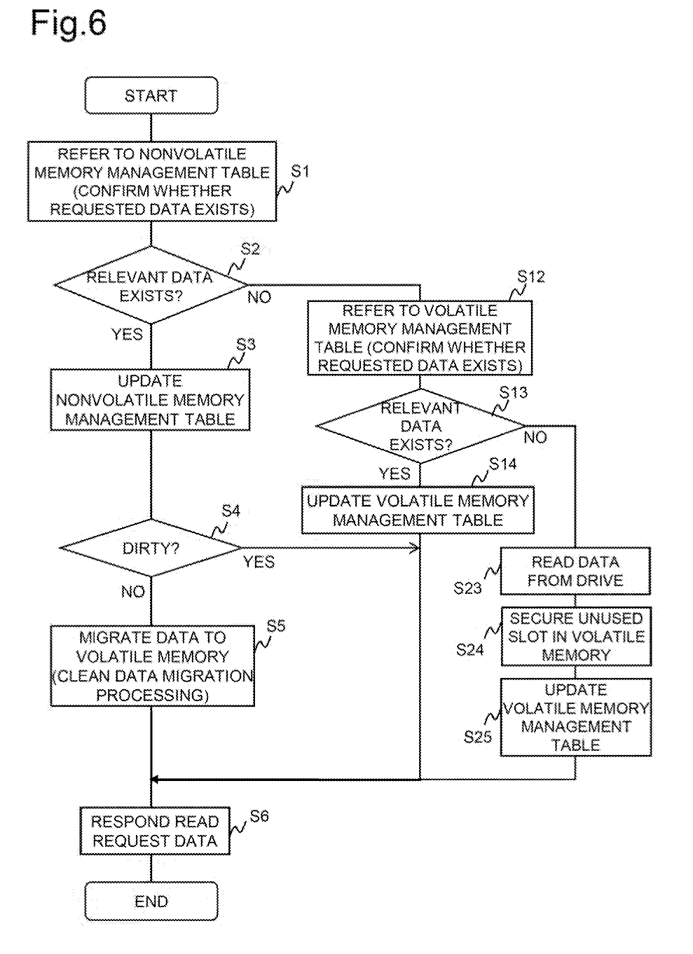

Next, with reference to FIG. 6, we will describe the flow of the process when the storage subsystem 10 according to the embodiment, of the present invention receives a read request, from the host 2. When the host 2 issues an access request (such as a read request or a write request) to the logical volume provided by the storage subsystem 10, it issues a request including the LUN of the logical volume and the position information (LBA) within the logical volume to the storage subsystem 10. When the processor 141 of the storage subsystem 10 receives a read request, it refers to the respective rows of the nonvolatile memory management table 260 based on the information of the LUN of the access target logical volume and the LBA within the logical volume included in the read request, and confirms whether the slot storing the read target data exists in the nonvolatile memory 144 or not (S1). Specifically, it refers to the LUN (200-2) and the LBA (200-4) of each row of the nonvolatile memory management table 260, and determines whether a row exists storing the same information as the set of LUN and LBA of the access target logical volume included in the read request. If such row exists, it further refers to the attribute 200-8, and determines whether the attribute 200-8 is Dirty or Clean. If the attribute 200-8 is Dirty or Clean, it means that the slot storing the read target data exists in the nonvolatile memory 144.

As a result of referring to the nonvolatile memory of S1, if it is determined that the slot storing the read target data exists in the nonvolatile memory 144 (S2: YES), the procedure advances to S3. In S3, the processor 141 updates the contents of the nonvolatile memory management table 260. Specifically, it adds 1 to the reference count 200-6, and stores (current time-time stored in last accessed time 200-5) in the access cycle 200-7. Then, it updates the contents of the last accessed time 200-5 to the current time.

In S4, the processor 141 determines whether the attribute 200-8 of the slot storing the read target data is Dirty or not, and if it is not Dirty (S4: No; in this case, the attribute 1200-8 is Clean), the procedure advances to S5. In S5, the processor 141 performs a process to migrate the data stored in the processing target slot (slot storing the read target data) to the volatile memory (called a clean data migration processing), which will be described in detail later.

As a result of referring to the nonvolatile, memory of S1, when the slot storing the read target data does not exist in the nonvolatile memory 144 (S2: NO), the procedure advances to S12. In S12, the processor 141 refers to the volatile memory management table 250, and confirms whether the slot storing the read target data exists in the volatile, memory 143 or not. This process is substantially similar to the process performed in S1 (same process except for referring to the volatile memory management table 250 instead of referring to the nonvolatile memory management table 260). As a result, when it is determined that the slot storing the read target data exists in the volatile memory 143 (S13: YES), the procedure advances to S14. In S14, the processor 141 updates the contents of the volatile memory management table 250. This process is substantially similar to S3, and the information of the reference count 200-6, the access cycle 200-7 and last accessed time 200-5 are updated.

If the slot storing the read target data does not exist in the volatile memory 143 (S13: NO), the procedure advances to S23 and thereafter. In S23, the processor 141 reads the read target data from the drive 121, and in S24, the processor 141 selects an unused slot to slot having no value stored in the LUN 200-2 and the LBA 200-4 in the volatile memory management table 250, or a slot where the value in the attribute 200-8 is NA) of the volatile memory 143, and stores the data read from the drive 121 to the relevant slot.

Thereafter, in S25, the processor 141 stores information related to the slot storing the data in the volatile memory management table 250. As an example, we will assume a case where the slot having slot, number N is selected by the process of S24. In that case, the processor 141 updates all information from the LUN 200-2 to the attribute 200-8 of the entries in the volatile memory management table 250 storing the information related to the slot having slot number N. The information of the LUN and the LBA specified by the read request are respectively stored in LUN 200-2 and LBA 200-4. Further, the information of the tier (any one of Tier1 through Tier3) to which the logical volume specified by the read request belongs is stored in Tier 200-3. Clean is stored in attribute 200-8. Current time is stored in last accessed time 200-5, and 1 is stored in reference count 200-8. Further, zero is stored in access cycle 200-7.

Lastly, the processor 141 reads the read target data from the volatile memory 143 or the nonvolatile memory, and returns the same to the host 2 (S6). Thereby, the read processing is completed.

The flow of the read processing is not restricted to the order described above, and other various modifications can be considered. For example, if the read target data exists in the nonvolatile memory 144, it is possible to read the read target data from the nonvolatile memory 144 prior to executing S4 or S5, and to return the same to the host 2. Further, if the read target data does not exist in either the volatile memory 143 or the nonvolatile memory 144, the data is read from the drive 121 by performing the processes of S23 and S24 and the read target data is stored in the volatile memory 143, but it is also possible to return the read target data to the host 2 before or simultaneously as storing the read target data in the volatile memory 143.

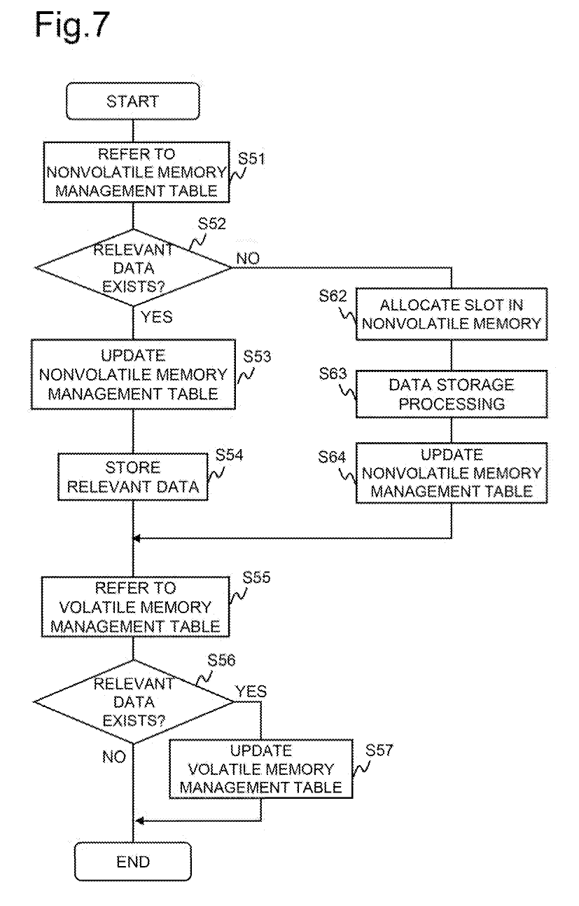

Next, the flow of the process when the storage subsystem 10 according to the preferred embodiment of the present invention receives A write request from the host 2 will be described with reference to FIG. 7. When the host 2 issues a write request to the logical volume provided by the storage subsystem 10, it issues a request including the LUN of the logical volume and the position information (LBA) within the logical volume to the storage subsystem 10. When the processor 141 of the storage subsystem 10 receives the write request, it refers to the respective rows of the nonvolatile memory management table 260 based on the information of the LUN of the access target logical volume and the LBA within the logical volume included in the write request, and confirms whether the slot storing the read target data exists in the nonvolatile memory 144 or not (S51). Specifically, it refers to the LUN (200-2) and the LBA (200-4) of the respective rows (entries) in the nonvolatile memory management table 260, and determines whether there exists an entry storing the same information as the set of the LUN and the LBA of the access target logical volume included in the write request. If such entry exists, it means that the slot for storing the write target data is already allocated in the nonvolatile memory 144.

As a result of referring to the nonvolatile memory of S51, if it is determined that the slot, for storing the write target data is already allocated in the nonvolatile memory 144 (S52: YES), the procedure advances to S53. In S53, the processor 141 updates the contents of the nonvolatile memory management table 260. The process performed in S53 is the same as S3. That is, a process is performed to add 1 to the reference count 200-6 and to store the (current time—time stored in last accessed time 200-5) in the access cycle 200-7. Then, the current time is stored in the last accessed time 200-5.

In S54, the processor 141 stores the write data received from the host 2 in the slot of the nonvolatile memory 144. In S55, the processor 141 refers to the volatile memory management table 250, and determines whether the slot storing the data of the position by the write request (LUN and LBA of access target logical volume) exists in the volatile memory 143 or not. If the slot storing the data of the position designated by the write request does not exist in the volatile memory 143 (S56: NO), the write processing is ended without doing anything, but if it exists (S56: YES), the processor 141 changes the attribute 200-8 of the row regarding the relevant slot in the volatile memory management table 250 to NA (S57), and ends the write processing. The reason for performing the process of S57 is that if the slot storing the data in the position specified by the write request exists in the volatile memory 143, that data is an older data (that is, invalid data) than the data stored in the slot of the nonvolatile memory 144 in S54.

If it is determined that the slot for storing the write target data is not allocated in the nonvolatile memory 144 (S52: NO), the procedure advances to S62. In S62, the processor 141 selects a slot for storing write data in the nonvolatile memo 144. Specifically, a slot having no values stored in the LUN 200-2 and the LBA 200-4, or the slot where the attribute 200-8 is NA, is selected from the rows in the nonvolatile memory management table 260. Further, if there is no slot where no values are stored in the LUN 200-2 and the LBA 200-4, or if there is no slot where the attribute 200-8 is NA, it selects a slot, having an oldest last accessed time 200-5 out of the slots whose attribute 200-8 is Clean. In S63, the processor 141 stores the write data received from the host 2 in the slot allocated in S62.

Then, in S64, the processor 141 stores the information related to the slot storing the data in the nonvolatile memory management table 260. This process is similar to the process of S25. After the process of S64 is completed, the processor 141 executes the processes of S55 and thereafter described earlier, and ends the write processing.

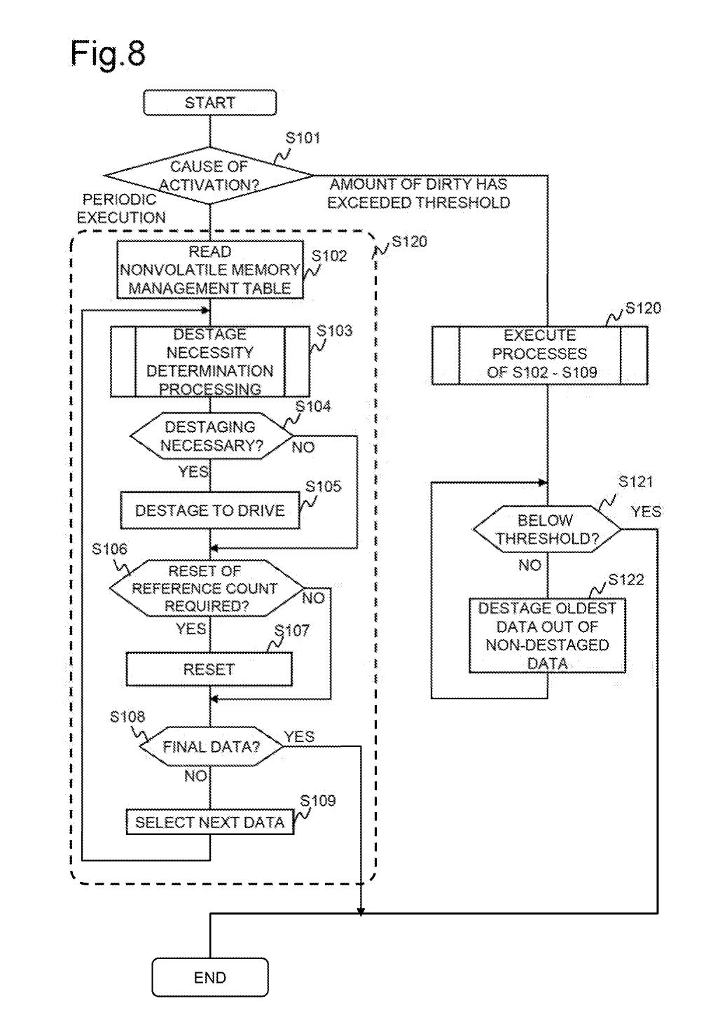

As described with reference to FIG. 7, the write data from the host 2 is stored as dirty data to the slot of the nonvolatile memory 144. Dirty data is not permanently retained in the nonvolatile memory 144, and will be destaged to the drive 121 at a certain point, of time. In the storage subsystem 10 according to the present embodiment, the destage processing is executed periodically by a cycle designated by the destage cycle 301, and in addition, the destage processing is also executed when the processor 141 detects that the amount of dirty data in the nonvolatile memory 144 has exceeded a certain threshold. Further, the detection of the amount of dirty data can be calculated by counting the number of slots where the attribute 200-8 in the nonvolatile memory management table 260 is Dirty. With reference to FIG. 8, the flow of the destage processing executed by the storage subsystem 10 according to the preferred embodiment of the present invention will be described.

In S101, the processor 141 confirms the cause of activation on whether the current destage processing has been activated periodically or activated since the amount of dirty data has exceeded a certain threshold. If the process has been activated periodically, the procedure advances to S102, and if the process has been activated since the amount of dirty data has exceeded a certain threshold, the procedure advances to S120.

At first, the process of S102 and thereafter will be described. In S102, the processor 141 confirms the nonvolatile memory management table 260 in the order starting from the initial row, and selects a row where the attribute 200-8 is set to Dirty. In S103, the processor 141 executes a destage necessity determination processing, which is a process for determining whether the data in the slot specified by the row selected in S102 (or in S109 described later) should be destaged or not. This process will be described in detail later.

When it is determined that destaging is necessary in S103 (S104: YES), the procedure advances to S105. In S105, the processor 141 destages the data in the relevant slot to the drive 121. When the destaging is completed, the procedure changes the attribute 200-8 of the relevant row in the nonvolatile memory management table 260 to Clean, and advances to S106. On the other hand, if it is determined that destaging is not necessary (S104: NO), the procedure advances to S106 without executing S105.

In S106, the processor 141 determines whether it is necessary to reset the reference count 200-6 of the relevant slot. Specifically, it calculates the difference between the current time and the last accessed time 200-5 of the relevant slot, and if this difference is equal to or greater than the reference count resetting cycle 304, the processor 141 determines that the reset of the reference count 200-6 of the relevant slot is necessary (S106: YES), and updates the value of the reference count 200-6 to zero (S107). If not, it determines that it is not necessary to reset the reference count 200-6 of the relevant slot (S106: NO), and advances to S108 without performing the process of S107.

In S108, the processor 141 determines whether the processes of S103 through S107 have been performed for all the rows of the nonvolatile memory management table 260, and if an unprocessed row exists (S108: NO), it selects the next row (whose attribute 200-8 is Dirty) in the nonvolatile memory management table 200 in S109, and executes the processes of S103 and thereafter. If an unprocessed row does not exist (S108: NO), the destage processing is ended. In the following description, the processes of S102 through S109 are referred to as “S120”.

Next, we will describe the process performed when the destage processing has been activated since the amount of dirty data has exceeded a certain threshold (S101: exceeded dirty amount threshold). In this case, the processor 141 first executes the processes of S102 through S109 (S120). Thereafter, in S121, the processor 141 determines whether the amount of dirty data in the nonvolatile memory 144 has become equal to or smaller than the threshold, and if it has not become equal to or smaller than the threshold (S121: NO), it performs the process of destaging the oldest data (data stored in the slot where the last accessed time 200-5 is oldest of the slots whose attribute 200-8 is Dirty) out of the dirty data (S122), and repeats the same until the amount of dirty data has become equal to or smaller than the threshold. When the amount of dirty data has become equal to or smaller than the threshold (S121: YES), the destage processing is ended.

Further, if the destage processing has been started since the amount of dirty data has exceeded a certain threshold, the process of S120 (the execution of processes of S102 through S109) is not necessary, and it is also possible to perform only the processes of S121 and S122.

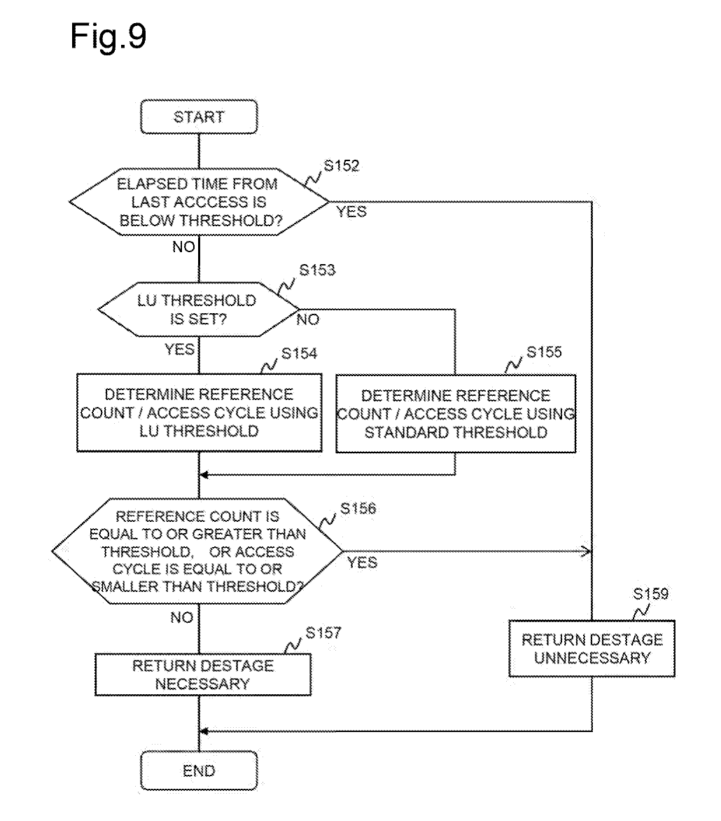

Next, the process of S103 of FIG. 8 (destage necessity determination processing) will be described with reference to FIG. 9.

In S152, the processor 141 refers to the last accessed time 200-5 of the row of the nonvolatile memory management table 260 storing the information related to the destage necessity determination target slot selected in S102 (or S109) of FIG. 8, and calculates the difference between the current time and the last accessed time 200-5. If this difference is smaller than a destageable elapsed time 302 (S152: YES), it is determined that destaging is unnecessary (S159), and a notice notifying that destaging is unnecessary is sent to the destage processing, and the destage necessity determination processing is ended.

On the other hand, if the difference between the current time and the last accessed time 200-5 is not less than the destageable elapsed time 302 (S152; NO), the procedure advances to S153. In S153, it is determined whether the reference count per LU 352 is set or not for the LU of the processing target slot.

Now, we will describe the information related to the reference count per tier 351 and the reference count per LU 352 with reference to FIG. 5. During the process of determining whether destaging is necessary or not in the preferred embodiment of the present invention, the reference count (reference count 200-6 stored in the nonvolatile memory management table 260) of the slot is used as one of the references for determining whether destaging is required or not, and if the reference count of the slot is smaller than a given threshold, it is determined that destaging is required. This threshold is determined for each logical volume or each tier being the final storage destination of the data cached in the slot. The reference count per tier 351 is a group of thresholds determined for each tier, and the reference count per LU 352 is a group of thresholds determined for each logical volume.

As an example, we will consider a case where the content of the nonvolatile memory management table 260 is as shown in the table of FIG. 3. In this case, dirty data is stored in the slot having a slot number (slot #200-1) 1 (since the value in attribute 200-8 is Dirty). The LUN 200-2 of the logical volume being the final storage destination of the data stored in the slot, is 1, and the tier 200-3 to Which the relevant logical volume belongs is Tier1. Then, we will assume a case where the reference count per tier 351 and the reference count per LU 352 are set as shown in FIG. 5. At this time if the information in the reference count per tier 351 is used as the threshold, 50 is set as the reference count of Tier1 (351-1), so that it is determined that if the reference count of the dirty data stored in the slot of slot number (slot # 200-1) 1 is 50 times or greater, destaging is unnecessary, and if the number is smaller than 50 times, destaging is necessary. However, when the information of the reference count per LU 352 is used as the threshold, since 40 is set as the reference count (352-1) of LUN number 1, it is determined that destaging of dirty data stored in the slot having slot number (slot #200-1) 1 is not necessary if the reference count is 40 times or greater, and destaging is necessary if the number is less than 40 times.

In the storage subsystem 10 according to the embodiment of the present invention, the administrator must necessarily set the information of the reference count per tier 351 for all the tiers. On the other hand, the reference count per LU 352 does not necessarily have to be set. The administrator should set the information of the reference count per LU 352 only when it is necessary to determine the necessity of destaging using a threshold other than the threshold set in the reference count per tier 351 for a specific logical volume. If both the reference count per tier 351 and the reference count per LU 352 are both set for the logical volume or the tier being the final storage destination of the data stored in the destage necessity determination target slot, the storage subsystem 10 performs the destage necessity determination processing using the reference count per LU 352, and if only the reference count per tier 351 is set, the destage necessity determination processing is performed using the reference count per tier 351. As for the logical volume whose LUN number is 1 described in the above example, both the thresholds of the reference count per tier 351 and the reference count per LU 352 are set, but in that case, the information of the reference count per LU 352 is used as the threshold to determine whether destaging is required or not.

We will now return to the description of FIG. 9. In S153, the processor 141 refers to the LUN (LUN 200-2 of the nonvolatile memory management table 260) of the logical volume being the final storage destination of the data stored in the destage necessity determination target slot, and determines whether the reference count per LU 352 is set. If the LUN 200-2 is 1, it is determined whether the reference count information of the logical volume whose LUN number is 1 is stored in the reference count per LU 352 or not. If it is set (S153: YES), the processor 141 uses the value set in the reference count per LU 352 as the threshold, and determines whether the reference count of the destage necessity determination target slot (reference count 200-6 of the nonvolatile memory management table 260) is equal to or greater than the threshold (S154). If it is not set (S153: NO), the processor 141 uses the information set in the reference count per tier 351 as the threshold, and determines whether the reference count of the destage necessity determination target slot (reference count 200-6 of the nonvolatile memory management table 260) is equal to or greater than the threshold (S155).

As a result of the determination of S154 or S155, if the reference count of the destage necessity determination target slot is equal to or greater than a threshold (S156: YES), the procedure advances to S159 where it is determined that destaging of the relevant slot is unnecessary, and the destage necessity determination processing notifies that destaging is unnecessary to the destage processing program and ends the process. On the other hand, if the reference count of the destage necessity determination target slot is not equal to or greater than the threshold (S156: NO), the procedure advances to S157, where the procedure notifies that destaging of the relevant slot is necessary to the destage processing program, and ends the process. Thereby, the data having a relatively high access frequency will remain in the disk cache without being destaged, so that the effect of improvement of the performance by the cache can be enhanced.

The above has described the flow of the destage necessity determination processing. In the destage necessity determination processing described above, whether destaging is required or not is determined using the reference count, but it is also possible to utilize the access cycle instead of the reference count. For example, in S156, it is possible to determine whether the access cycle (access cycle 200-7 of the nonvolatile memory management table 260) of the destage necessity determination target slot is equal to or smaller than a threshold or not, to determine that destaging is unnecessary if the access cycle, is equal to or smaller than the threshold, and to determine that destaging is necessary if the access cycle is greater than the threshold. In this case, it is possible to set the access frequency threshold per tier or the access frequency threshold per LU, instead of the information of the reference count per tier 351 or the reference count per LU 352 set in FIG. 5.

According to the example described above, the threshold for determining whether destaging is required or not using the reference count or the access cycle is set for each logical volume or each tier to perform the destage necessity determination, but as a modified example, it is possible to set only the threshold for each logical volume, without setting the threshold for each tier. In that case, the processes of S153 and S155 become unnecessary. In another example, only the threshold for each tier should be set, without setting the threshold for each logical volume. In that case, the processes of S153 and S154 become unnecessary.

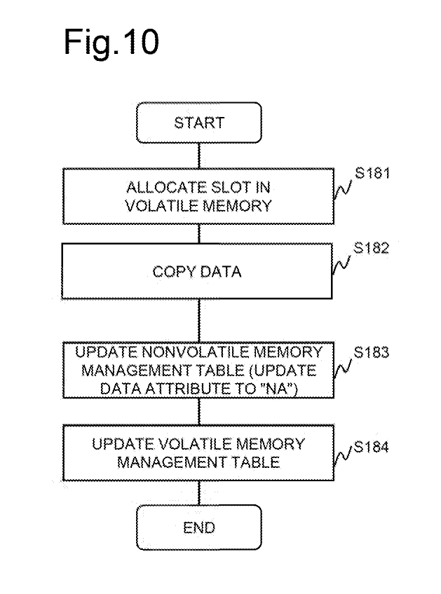

Next, the clean data migration processing will be described with reference to FIG. 10. The clean data migration processing is a process executed by S5 of the read processing described with reference to FIG. 6. If the data set as the read target by the read request from the host 2 exists in the nonvolatile memory 144, and that data is not dirty (in other words, Clean), the processor 141 migrates that data from the nonvolatile memory 144 to the volatile memory 143, and increases the unused area in the nonvolatile memory 144. In the embodiment of the present invention, this process is called a clean data migration processing.

In S181, the processor 141 selects an unused slot in the volatile memory so as to copy the data in the slot of the nonvolatile memory 144 being the processing target in the read processing to a volatile memory. This process is similar to the process of S24 in FIG. 6. In S182, the processor 141 copies the data in the slot of the nonvolatile memory 144 being the processing target in the read processing to the unused slot in the volatile memory selected in S181.

In S183, the processor 141 invalidates the data in the slot of the nonvolatile memory 144 having been storing the copied data. Specifically, it changes the content of the data attribute 200-8 of the row in the nonvolatile memory management table 260 storing the management information corresponding to the relevant slot to “NA”.

Lastly, in S184, the processor 141 stores the information related to the slot in the volatile memory 143 having copied the data in S182 to the volatile memory management table 250. This process is similar to S25 of FIG. 6, but in S184, the information stored in the reference count 200-6 and the access cycle 200-7 differs from the information stored in 825. In S184, the processor 141 stores the value having added 1 to the value of the reference count 200-6 stored in the nonvolatile memory management table 260 into the reference count 200-6 of the volatile memory management table 250. Further, (current time—last accessed time 200-5 stored in the nonvolatile memory management table 260) is stored in the access cycle 200-5.

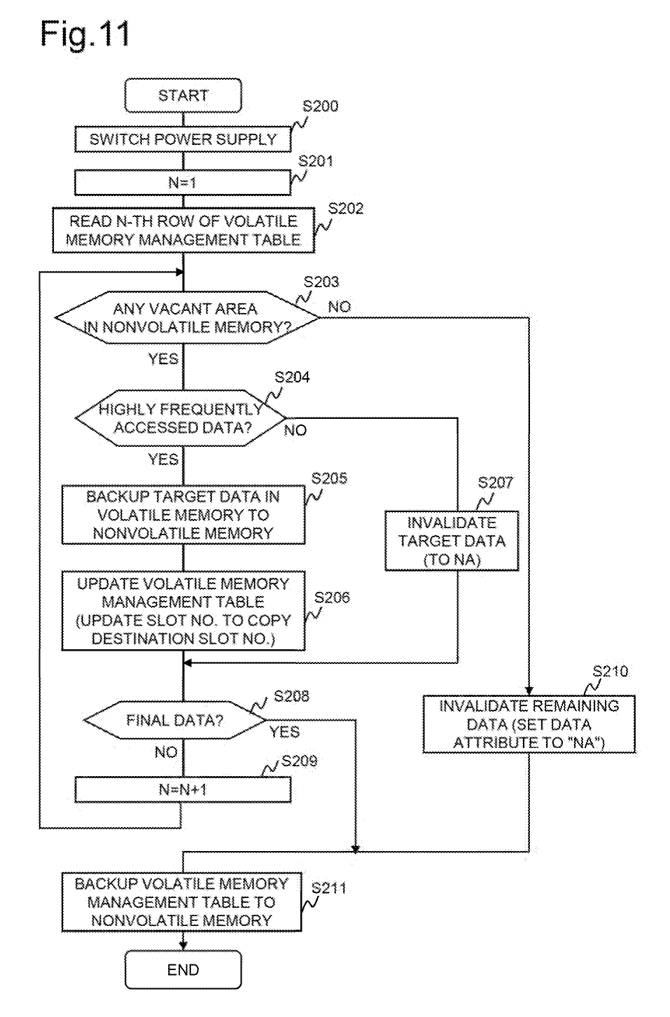

Next, with reference to FIG. 11, the flow of the backup processing performed when the power supply from the external power supply is stopped due to power outage and the like will be described. When the controller 11 detects that the power supply from the exterior has stopped, it switches the power supply source to the battery (S200). Thereafter, the processor 141 executes the processes of S201 and thereafter.

In the backup processing, a variable N for specifying the processing target entry within the volatile memory management table is prepared for example in the memory 142, and the table is used. In S201, the processor 141 initializes (substitutes 1 in) the value of the variable N. In S202, the processor 141 reads the information stored in the Nth row of the volatile memory management table 250 in the volatile memory 143. In S203, the processor 141 determines whether there is a vacant slot (an unused area, an invalid area, or a slot where the attribute 200-8 is Clean; that is, in the present determination, the slots other than those storing dirty data are determined as a vacant slot) in the nonvolatile, memory by referring to the contents of the nonvolatile memory management table 260, and if there is no vacant slot (S203: NO), the processor 141 updates the attribute 200-8 to “NA” in the respective rows of the Nth row and beyond of the volatile memory management table 250 (S210). Thereby, of the respective slots within the volatile memory 143, the slots to which data save (copy) has not been performed to the nonvolatile memory 144 are all invalidated. Then, in S211, the processor 141 copies the contents of the volatile memory management table 250 to the volatile memory management table backup area 250′ in the nonvolatile memory 144 (S21), and ends the process.

In the determination of S203, if is determined that there is a vacant slot (S203: YES), S204 and subsequent processes are executed. In S204, the processor 141 determines whether the data stored in the slot (slot specified by slot #200-1 of the relevant row) corresponding to the information stored in the Nth row of the volatile memory management table 250 is a highly frequently accessed data or not. Whether the data is a highly frequently accessed data or not is performed, for example, by executing the process similar to S153 through S156 of the destage necessity determination processing. That is, if the reference count (the reference count 200-6 of the Nth row of the volatile memory management table 250) is equal to a given threshold or greater, the data is determined as highly frequently accessed data, and if the reference count is below the given threshold, the data is determined not to be a highly frequently accessed data. However, the method for determining whether a data is highly frequently accessed data or not is not restricted to this method, and other methods (such as using the access cycle 200-7 and determining that a data is a highly frequently accessed data if the access cycle 200-7 is equal to or smaller than a given threshold) can also be used.

In S204, when it is determined that the process target slot is highly frequently accessed data (S204: YES), the processor 141 performs the processes of S205 and S206. In S205, the processor 141 copies the data in the process target slot (slot specified by slot #200-1) within the volatile memory to the nonvolatile memory 144. When copying the data to the nonvolatile memory, a process similar to S62 and S63 of FIG. 7 (allocating the slot for storing data in the nonvolatile memory 144, and copying the data to the allocated slot) is performed. In S206, the processor 144 updates the information related to the process target vow (Nth row) in the volatile memory management table 250. Specifically, the slot #200-1 is changed to the slot number of the copy destination nonvolatile memory 144.

When it is determined that the process target slot is not a highly frequently accessed data in S204 (S203: NO), the processor 141 changes the attribute 200-8 of the process target row within the volatile memory management table 250 to “NA” (S207).

Thereafter, in S208, the processor 141 determines whether the processing related to all the rows in the volatile memory management table 250 has been completed or not. When the processing is completed for all the rows in the volatile memory management table 250, the processor 141 performs the process of S211 described earlier, and ends the backup processing.

In S208, if it is determined that the processing has not been completed for all the rows in the volatile memory management table 250 (S208: NO), the processor 141 adds 1 to variable N (S209), and repeatedly performs the processes of S202 and thereafter for all the rows within the volatile memory management table 250.

According to this process, out of the data stored in the volatile memory 143, the highly frequently accessed data is backed up in the nonvolatile memory 144, and the contents of the volatile memory management table 250, which is the management information of the relevant data, is backed up in the volatile memory management table backup area 250′ within the nonvolatile memory 144. If the battery 13 does not retain the amount of electric power necessary to back up all the highly frequently accessed data in the volatile memory 143 to the nonvolatile memory 144 (such as when there is an extremely large amount of data determined as highly frequently accessed data), this process will fail. However, at least all the dirty data is stored in the nonvolatile memory 144, so that the data written from the host 2 will not be lost, and the data can be protected without fail.

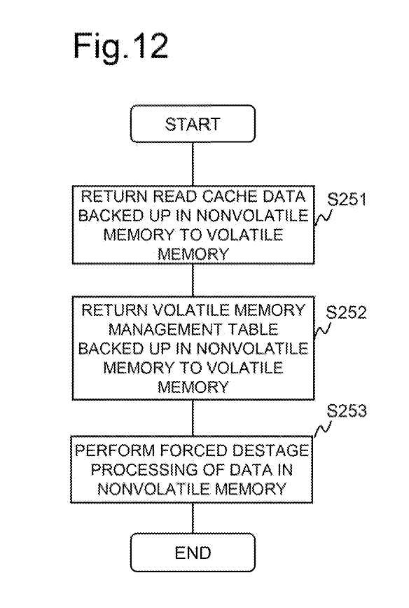

Next, with reference to FIG. 12, we will describe the recovery processing performed when the external power supply has recovered and the power supply from the external power supply is resumed. When the controller 11 detects that the power supply from the external power supply has been resumed, the power supply source is switched to the external power supply, and the process of FIG. 12 is started.

In S251, the processor 141 refers to the contents of the volatile memory management table backed up in the volatile memory management table backup area 250′, searches the slot where the attribute 200-8 is Clean (backed up in the nonvolatile memory 144), and copies the data of the relevant slot to the volatile memory 143. When performing the copying process, the copying is performed so that the slot number is not changed. For example, the data stored in slot number n within the nonvolatile memory 144 is controlled to be copied to the slot having slot number n in the volatile memory 143. According to this process, the read cache data backed up in the nonvolatile memory from the volatile memory during the backup processing will be returned again to the volatile memory.

In S252, the processor 141 copies the contents of the volatile memory management table backed up in the volatile memory management table backup area 250′ to the volatile memory 143.

Finally in S253, the processor 141 destages the dirty data within the nonvolatile memory 144 to the drive 121, and ends the recovery processing. After this recovery processing, when access to the data restored in the volatile memory by the relevant recovery processing is received from the host 2, it becomes possible to return the data in the volatile memory 143 to the host 2 without accessing the drive 121, and the deterioration of access performance (response time) can be prevented.

The above description describes the cache control method executed in the storage subsystem according to the preferred embodiment of the present invention. According to the storage subsystem of the present invention, the disk cache is composed of a nonvolatile memory capable of retaining data even when there is no power supply from the external power supply or the battery, and a volatile memory, wherein control is performed so that the data subjected to read access from a superior device such as a host computer is stored in the volatile memory, and write data from the superior device is stored in the nonvolatile memory, so that even when the power supply to the storage subsystem is discontinued due to power failure and other causes, the dirty data in the disk cache will not be lost. Moreover, when power supply failure occurs, the data having a high possibility of being accessed from a superior device out of the data stored in the volatile memory is backed up in the nonvolatile memory, and when the power supply is recovered, the data backed up in the nonvolatile memory is returned to the volatile memory, so that the state of the disk cache can be recovered to the same state as before the power supply failure has occurred. Thereby, even after the power supply failure has occurred, the effect of improving the access performed by the cache can be maintained.

The preferred embodiment of the present invention has been described, but this embodiment is a mere example for illustrating the present invention, and it is not intended to restrict the present invention to the embodiment described above. The present invention can be implemented in various other modified forms. For example, as mentioned earlier, the number of controllers 11 within the storage subsystem 10 is not restricted to the number illustrated in FIG. 1. Furthermore, the number of components in the controller 11, such as the number of processors 141, FE I/Fs 112, BE I/Fs 113 and so on, is not restricted to the number illustrated in FIG. 1, and the present invention is also effective even if there are multiple processors.

According further to the storage subsystem of the present embodiment, in the backup processing, whether the data in each slot is a highly frequently accessed data or not is determined in the order starting from the initial row of the volatile memory management table, that is, in the order starting from the slot having a smallest slot number, and the data determined to have a high access frequency is migrated from the volatile memory to the nonvolatile memory, but the backup processing is not restricted to this method. For example, it is possible to constantly sort and store the respective rows in the volatile memory management table to be in the order of higher access frequency (reference count or access cycle), and when performing the backup processing, performing backup of the slots in the order starting from the slot stored at the initial row of the volatile memory management table. Further, the data being the backup target is not necessarily restricted to those having a high access frequency, and other various methods can be adopted as long as the method performs backup of the data determined to have a high possibility of being accessed again from a superior device. For example, if data of a specific LBA in the logical volume has a tendency to be accessed frequently, and if the data of the relevant LBA is cached in the volatile memory, a method can be adopted to perform backup of that data in a prioritized manner.

In contrast, if there is not much battery power, it may be better to prioritize backup of as much data as possible, instead of carefully selecting the data to be set as the backup target. Therefore, in such case, it is possible to omit the process for determining the access frequency and the like of each slot (process of S204 in FIG. 11), and to perform backup of data to the nonvolatile memory unconditionally in the order starting from the slot having the smallest slot number.

The components described as programs according to the present embodiment can also be realized via hardware using a hard wired logic or the like. Moreover, it is possible to adopt a configuration where the respective programs within the embodiment are stored and provided in storage media such as CD-ROMs and DVDs.

### REFERENCE SIGNS LIST

7: Management terminal

10: Storage subsystem

11: Storage controller

12: Disk unit

13: Battery

111: MPB

112: FE I/F

113: BE I/F

114: CMPK

115: Switch

121: Drive

141: Processor (MP)

142: Memory

143: Volatile memory

144: Nonvolatile memory

1. A storage subsystem comprising:
a controller for receiving an I/O request from a host, the controller equipped with a disk cache including a volatile memory and a nonvolatile memory;
a battery for supplying power to the controller; and
one or more storage media connected to the controller;
wherein the storage subsystem is operated using electric power supplied from an external power supply in a normal state,
wherein the controller is configured to:
use electric power supplied from the battery to migrate data having a high possibility of being accessed again from the host out of the data stored in the volatile memory to the nonvolatile memory when power supply from the external power supply has stopped; and
migrate the data having been migrated from the volatile memory to the nonvolatile memory back to the volatile memory when the power supply from the external power supply has recovered, and
wherein the controller is further configured to:
store a write data from the host to the nonvolatile memory;
read the data from the storage media and store the same in the volatile memory if a read target data subjected to a read request from the host does not exist in the disk cache;
return the read target data stored in the volatile memory to the host if the read target data is not stored in the nonvolatile memory and is stored in the volatile memory;
return the read target data stored in the nonvolatile memory to the host if the read target data is stored in the nonvolatile memory; and
migrate the read target data from the nonvolatile memory to the volatile memory if the read target data stored in the nonvolatile memory is reflected in the storage media.

2. (canceled)

3. (canceled)

4. (canceled)

5. (canceled)

6. The storage subsystem according to claim 1, wherein
the controller determines, based on a reference count or an access cycle of the data, whether data not reflected in the storage media out of the data stored in the nonvolatile memory satisfies a given condition or not, and
reflects the data not satisfying the given condition to the storage media.

7. The storage subsystem according to claim 6, wherein
the given condition is that the reference count of the data per unit time is equal or greater than a threshold.

8. The storage subsystem according to claim 7, wherein
the storage subsystem has multiple logical volumes formed using storage areas of one or more storage media,
the threshold is set for each of said logical volumes, and
the controller determines whether the given condition is satisfied or not based on the threshold set for the logical volume being a storage destination of the data stored in the nonvolatile memory.

9. The storage subsystem according to claim 7, wherein
the storage subsystem has multiple logical volumes formed storage areas of said one or more storage media,
the multiple logical volumes are managed to belong to one storage tier out of multiple storage tiers determined in the storage subsystem,
the threshold is set for each storage tier, and
the controller determines whether the given condition is satisfied or not based on the threshold set for the storage tier to which the logical volume being the storage destination of data stored in the nonvolatile memory belongs.

10. In a storage subsystem having a controller equipped with a disk cache including a volatile memory and a nonvolatile memory, a battery for supplying power to the controller, and one or more storage media connected to the controller, the storage subsystem being operated using electric power supplied from an external power supply in a normal state,
a method for controlling the storage subsystem comprising:
using, by the controller, electric power supplied from the battery to migrate data having a high possibility of being accessed again from the host out of the data stored in the volatile memory to the nonvolatile memory when power supply from the external power supply has stopped;
migrating, by the controller, the data having been migrated from the volatile memory to the nonvolatile memory back to the volatile memory when power supply from the external power supply has recovered;
storing, by the controller, the data in a nonvolatile memory in the disk cache when a write data from a host is received;
reading, by the controller, the data from the storage media and storing the same in a volatile memory in the disk cache when data corresponding to a read request from the host is not stored in the disk cache;
returning, by the controller, read target data subjected to a read request from the host stored in the nonvolatile memory to the host if the read target data is stored in the nonvolatile memory;
sending, by the controller, the read target data stored in the volatile memory to the host if the read target data is not stored in the nonvolatile memory and is stored in the volatile memory; and
migrating, by the controller, the read target data from the nonvolatile memory to the volatile memory if the read target data stored in the nonvolatile memory is reflected in the storage media.

11. (canceled)

12. (canceled)

13. (canceled)

14. (canceled)
